(19) United States
(12) Patent Application Publication
(10) Pub. No.: US 2002/0167152 A1
(43) Pub. Date: Nov. 14, 2002

(54) Panel assembly for deployment of an air bag

(76) Inventors: Darius J. Preisler, Macomb, MI (US); Jason T. Murar, Clinton Township, MI (US)

Correspondence Address: Lawrence G.Almeda, Brooks & Kushman P.C., 1000 Town Center, 22nd Floor, Southfield, MI, 48075-1351, US

(21) Appl. No.: 09/852,488

(22) Filed: May 10, 2001

(51) Int. Cl. B60R 21/16

(52) U.S. Cl. 280/728.3

(57) ABSTRACT

The present invention provides a panel assembly for deployment of an air bag into a vehicle compartment and to dissipate impact energy during a vehicle impact. The assembly comprises a panel member and an energy-dissipating impact member attached to the panel member. The panel member is attachable to a vehicle support structure. The panel member flexes to allow for deployment of the air bag into the vehicle compartment during impact of the vehicle. The energy-dissipating impact member attaches only to a retainer portion on an inner surface of the panel member to allow the flexing. The impact member is configured to contact the air bag disposed adjacent the door portion.

### BACKGROUND OF THE INVENTION

1. Field of the Invention

The present invention relates to a panel assembly for a vehicle having a compartment support structure, wherein the panel assembly is configured to allow for deployment of an air bag into a vehicle compartment and to dissipate impact energy during a vehicle impact.

2. Background Art

Improvements continue to be made on vehicle air bag deployment systems for vehicle impact situations. Currently, many panel members in vehicle compartments are configured to deploy an air bag therefrom into a vehicle compartment during impact of the vehicle. These panel members may be associated with a trim panel, e.g., a front panel and/or a side panel, of the vehicle. Such panel members may be attachable to a support structure, e.g., an A-pillar of the vehicle. Many panel members have hinged portions which serve as a passage or door through which the air bag deploys to facilitate in dissipating impact energy during a vehicle impact.

However, manufacturers are challenged with the growing need for a more simple configuration of such panel member without compromising the adequacy of deploying an air bag therefrom. Currently panel members configured to deploy an air bag therefrom during a vehicle impact may be relatively costly to manufacture. Thus, there is a need for manufacturers to provide an improved panel member which is more simply configured to deploy an air bag therefrom.

Manufacturers are also challenged with providing a panel member attachable to a compartment support structure having an impact member disposed therebetween for dissipating impact energy during a vehicle impact. Manufacturers are faced with a growing need to improve ways to dissipate impact energy against the panel member during a vehicle impact.

### SUMMARY OF THE INVENTION

It is an object of the present invention to provide a unitary panel member of a panel assembly attachable to a vehicle support structure for deployment of an air bag from the panel assembly.

It is another object of the present invention to provide a unitary panel member having a retainer portion and an integral door portion which flexes away from the retainer portion to allow for deployment of an air bag from the panel member as the retainer portion remains substantially stationary with respect to the door portion.

It is yet another object of the present invention to provide a panel assembly having unitary panel member to house a deployable air bag and an energy-dissipating impact member to facilitate dissipating impact energy during a vehicle impact, wherein the impact member is attached only to a retainer portion and not a door portion of the panel member.

It is still another object of the present invention to provide an energy-dissipating impact member attachable to a panel member, wherein the impact member is a molded cartridge having spaced ribs transversely formed thereon for dissipating impact energy.

It is another object of the present invention to provide an improved panel assembly for a vehicle having a compartment support structure, the panel assembly configured to allow for deployment of an air bag into a vehicle compartment and to dissipate impact energy during a vehicle impact. The assembly comprises a panel member and an energy-dissipating impact member attached to the panel member. The panel member is attachable to the support structure. The panel member has a retainer portion and a door portion formed integrally with the retainer portion. The door portion extends from the retainer portion. The panel member has an inner surface against which the air bag is positioned, wherein the inner surface is disposed adjacent the support structure when the panel member is attached to the support structure. The panel member is flexible to allow the door portion to flex with respect to the retainer portion for deployment of the air bag into the vehicle compartment during impact of the vehicle. The panel member further has an outer show surface opposite the inner surface. The energy-dissipating impact member attaches only to the retainer portion on the inner surface to allow the flexing of the door portion with respect to the retainer portion for air bag deployment while the retainer portion remains substantially stationary. The impact member has first and second sides, wherein the first side complements the inner surface for engagement thereto. The second side is configured to contact the air bag disposed adjacent the door portion.

In another embodiment, the present invention provides the improved panel assembly described above. In this embodiment, the panel member is configured concavely and has an inner surface which defines a recess in which the air bag is disposed. The panel member is sufficiently flexible such that the door portion is integrally hinged to the retainer portion to flex with respect to the retainer portion while the retainer portion remains substantially stationary to allow deployment of the air bag along the door portion into the vehicle compartment during impact of the vehicle. The impact member attaches only to the retainer portion on the inner surface and within the recess. The second side of the impact number is concavely configured to receive the air bag disposed adjacent the door portion.

Other objects, features, and advantages of the present invention will be apparent from the ensuing description in conjunction with the accompanying drawings.

### BRIEF DESCRIPTION OF THE DRAWINGS

FIG. 1 is an environmental view of a panel assembly in accordance with the present invention;

FIG. 2 is a perspective view of the panel assembly shown in FIG. 1;

FIG. 3 is a plan view of a panel member of the panel assembly in FIG. 2;

FIG. 4 is a plan view of an energy-dissipating impact member of the panel assembly;

FIG. 5 is an exploded view of the panel assembly attachable to a vehicle support structure;

FIG. 6a is a cross-sectional view of the panel assembly housing an air bag in a normal state taken along lines 6-6; and

FIG. 6b is a cross-sectional view of the panel assembly wherein the air bag is in a deployed state.

### DETAILED DESCRIPTION OF THE PREFERRED EMBODIMENTS

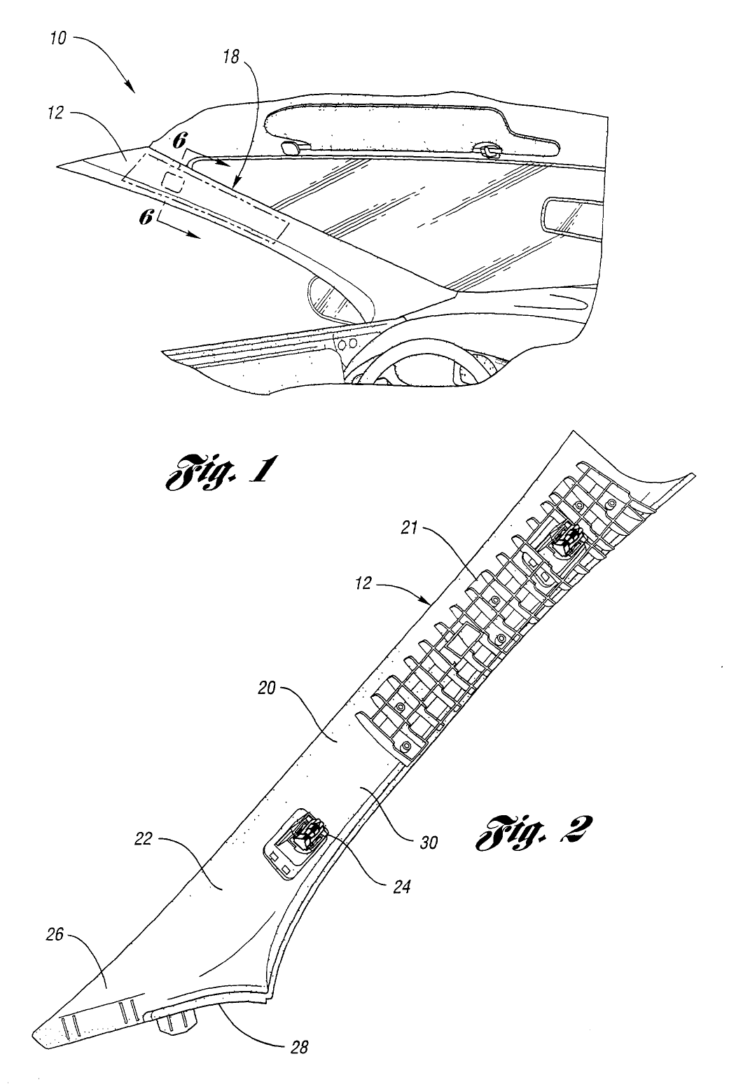

FIG. 1 illustrates vehicle 10 having panel assembly 12 mounted to a compartment support structure such as an A-pillar of the vehicle 10 to house an air bag (not shown) within panel assembly 12. In this embodiment, panel assembly 12 is disposed on a support structure which is an A-pillar of vehicle 10. Panel assembly 12 is configured to allow for deployment of an air bag (not shown) into vehicle compartment 18 and to dissipate impact energy during a vehicle impact. As noted below, panel assembly 12 in accordance with the present invention may be disposed on other pillars or panels within the vehicle compartment.

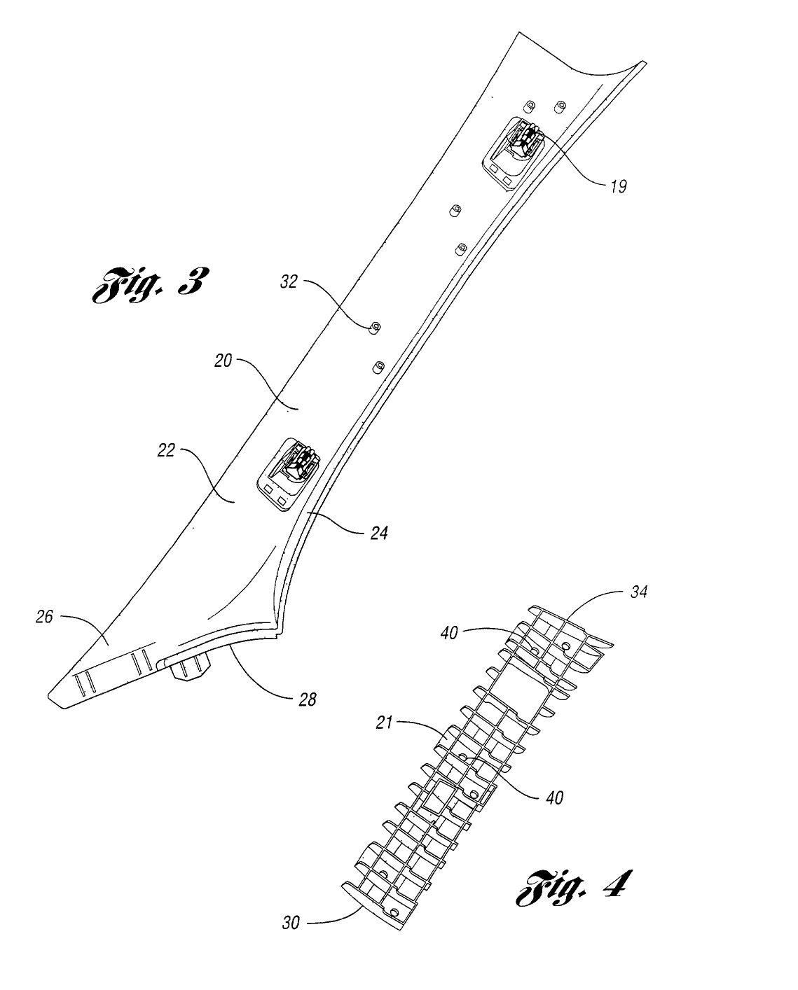

FIG. 2 depicts panel assembly 12 in accordance with the present invention. As shown, panel assembly 12 includes panel member 20 and energy-dissipating impact member 21 attached to the panel member 20 as described below. Panel member 20 has retainer portion 22 and door portion 24. Door portion 24 is formed integrally with retainer portion 22 and extends from retainer portion 22. In this embodiment, door portion 24 extends from retainer portion 22 at an arcuate portion of panel member 20. As shown, door portion 24 extends at about a 90° angle from retainer portion 24. Of course, door portion 24 may be formed to extend from retainer portion 22 at any suitable angle. Panel member 20 has inner surface 26 against which an air bag may be positioned. Panel member 20 is configured to be flexible in order to allow door portion 24 to flex with respect to retainer portion 22 for deployment of the air bag into vehicle compartment 18 during impact of vehicle 10. Thus, because door portion 24 and retainer portion 22 are injection molded together to form a single component, door portion 24 is effectively integrally hinged to retainer portion 22 such that panel member 20 is sufficiently flexible to flex door portion 24 with respect to retainer portion 22 while retainer portion 22 remains substantially stationary during deployment of the air bag. As shown in FIGS. 2 and 3, panel member 20 further includes an outer show surface 28 opposite inner surface 26. Panel member 20 is concavely formed and inner surface 26 defines recess 30 in which energy-dissipating impact member 21 and an air bag may be disposed. Moreover, retainer portion 22 includes hollow mounting posts 32 extending from inner surface 26. Hollow mounting posts 32 facilitate heat-staking of impact member 21 to retainer portion 22. In this embodiment, panel member 20 is configured to be attached to an A-pillar in vehicle compartment 18. However, panel member 20 in accordance with the present invention may be configured to be attached to any other pillar or panel within the vehicle compartment.

In this embodiment, panel member 20 and impact member 21 may be made of a thermoplastic material. For example, the panel member may be material made of a polycarbonate resin containing ecrylonitrile, butadiene, and styrene (PC-ABS) material, thermoplastic elastomer etherether (TEEE), polypropylene, the product having the trade name Santoprene™ supplied by Monsanto Company, or a thermoplastic polyolefinic (TPO) material.

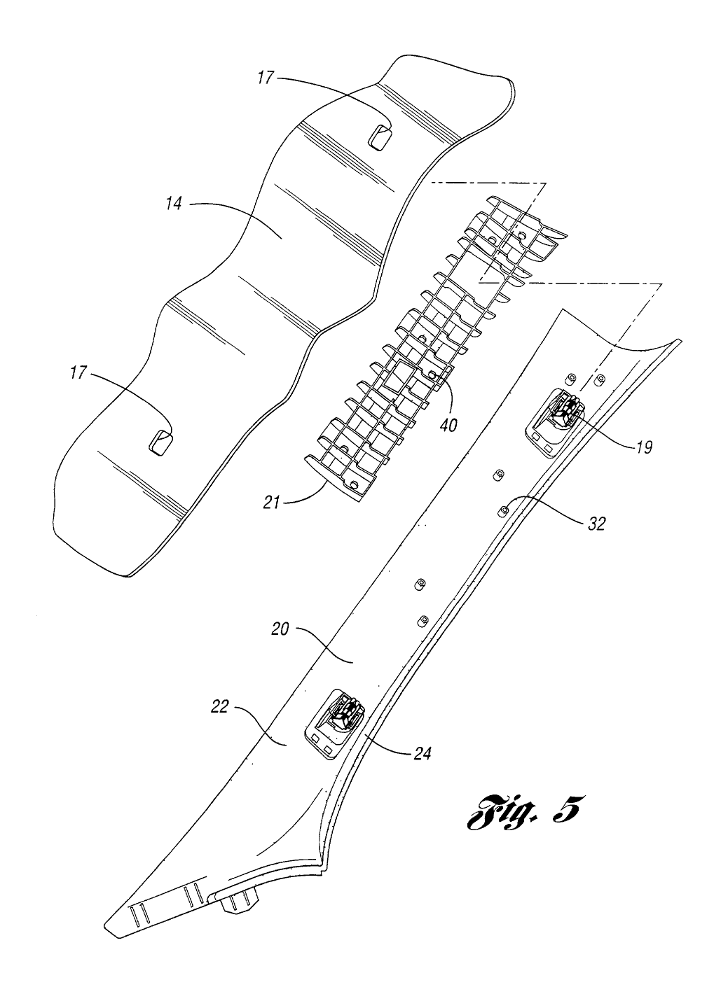

As shown in FIGS. 4 and 5, energy-dissipating impact member 21 has first and second sides 33, 34. The first side 33 is configured to complement inner surface 26 for engagement thereto. First side 33 substantially takes on the shape of inner surface 26 to which first side 33 is disposed. Second side 34 of impact member 21 is formed to cooperate with door portion 24 to house an air bag disposed between door portion 24 and second side 34 of impact member 21. As shown, impact member 21 attaches only to the retainer portion 22 (and not door portion 24) on inner surface 26. This allows the flexing of door portion 24 with respect to retainer portion 22 while retainer portion 22 remains substantially stationary during air bag deployment. In this embodiment, impact member 21 is a molded cartridge having spaced ribs 36 which are transversely formed thereon for dissipating impact energy during vehicle impact. Moreover, impact member 21 includes apertures 40 formed therethrough and through which the mounting posts 32 extend to facilitate heat-staking of impact member 21 to retainer portion 22. When mounting posts 32 extend through apertures 40, impact member 21 may be heat-staked onto retainer portion 22, thereby securing impact member 21 to panel member 20.

As shown in FIGS. 3 and 5, fastener 19 is attached by any suitable means onto inner surface 26 of panel member. Fastener 19 secures panel assembly 12 onto support structure 14 by being inserted through aperture 17 formed through support structure.

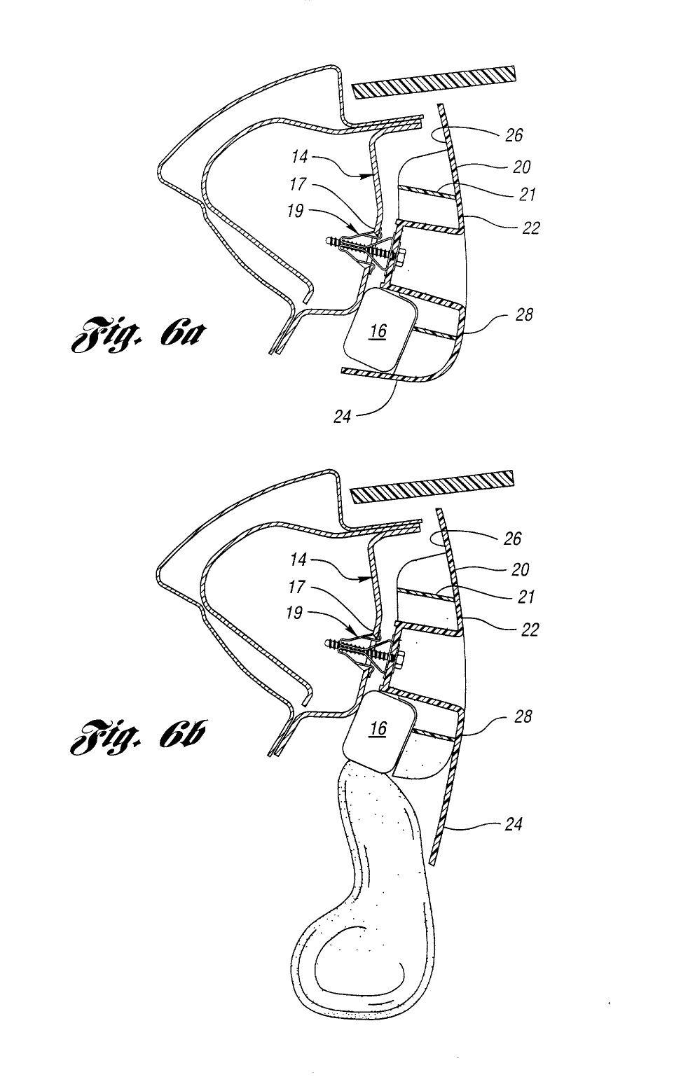

As shown in FIG. 6a, panel member 20 is attachable to support structure 14 to thereby attach panel assembly 12 to support structure 14. As shown, panel assembly 12 houses air bag 16 in a normal or non-deployed state. As mentioned above, energy-dissipating impact member 21 attaches only to retainer portion 22 and not door portion 24 in order to allow air bag 16 to be deployed through door portion 24 which flexes away from support structure 14 during deployment triggered by a vehicle impact. As shown, inner surface 26 is disposed adjacent support structure 14 when panel member 20 is attached to support structure 14. In FIG. 6b, door portion 24 has been flexed away from the support structure 14 by force of deployment of air bag 16. During a vehicle impact, door portion 24 flexes with respect to retainer portion 22 allowing deployment of air bag 16 into vehicle compartment 18. This is accomplished because impact member 21 is attached only to retainer portion 22 on the inner surface 26. Otherwise, if impact member 21 was attached to retainer portion 22 and to door portion 24, door portion would not be able to flex from retainer portion 22, preventing deployment of air bag 16 into a respective vehicle compartment. Moreover, impact member 21 facilitates dissipation of impact energy during a vehicle impact. The ribbed cartridge configurations of impact member 21 is configured to absorb impact energy placed thereon during a vehicle impact.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A panel assembly for a vehicle having a compartment support structure, the panel assembly configured to allow for deployment of an air bag into a vehicle compartment and to dissipate impact energy during a vehicle impact, the assembly comprising:
a panel member attachable to the support structure, the panel member having a retainer portion and a door portion formed integrally with the retainer portion and extending from the retainer portion, the panel member having an inner surface against which the air bag is positioned, the inner surface being disposed adjacent the support structure when the panel member is attached to the support structure, the panel member being flexible to allow the door portion to flex with respect to the retainer portion for deployment of the air bag into the vehicle compartment during impact of the vehicle, the panel member further having an outer show surface opposite the inner surface; and
an energy-dissipating impact member attached only to the retainer portion on the inner surface to allow the flexing of the door portion with respect to the retainer portion for air bag deployment while the retainer portion remains substantially stationary, the impact member having first and second sides, the first side complementing the inner surface for engagement thereto, the second side configured to contact the air bag disposed adjacent the door portion.

2. The assembly of claim 1 wherein the panel member is concavely formed and the inner surface defines a recess in which the impact member and air bag are disposed.

3. The assembly of claim 1 wherein the retainer portion on the inner surface includes a hollow mounting post extending therefrom.

4. The assembly of claim 3 wherein the impact member includes an aperture through which the mounting post extends to facilitate heat-staking of the impact member to the retainer portion.

5. The assembly of claim 1 wherein the impact member is a molded cartridge having spaced ribs transversely formed thereon for dissipating impact energy.

6. The assembly of claim 1 wherein the impact member includes spaced ribs transversely formed thereon for dissipating input energy.

7. The assembly of claim 6 wherein the impact member is heat-staked onto the retainer portion.

8. The assembly of claim 1 wherein the panel member is configured to be attached to a pillar in the vehicle compartment.

9. The assembly of claim 1 wherein the panel member is configured to be attached to a side panel in the vehicle compartment.

10. The assembly of claim 1 wherein the second side of the impact member is formed to cooperate with the door portion to house the air bag between the door portion and the second side of the impact member.

11. A panel assembly for a vehicle having a compartment support structure, the panel assembly configured to allow for deployment of an air bag into a vehicle compartment and to dissipate impact energy during a vehicle impact, the assembly comprising:
a panel member attached to the support structure, the panel member having a retainer portion and a door portion formed integrally with the retainer portion, the panel member configured concavely and having an inner surface which defines a recess in which the air bag is disposed, the panel member being sufficiently flexible such that the door portion is integrally hinged to the retainer portion to flex with respect to the retainer portion while the retainer portion remains substantially stationary to allow deployment of the air bag along the door portion into the vehicle compartment during impact of the vehicle, the panel member further having an outer show surface opposite the inner surface; and
an impact member attached only to the retainer portion on the inner surface and within the recess, the impact member having first and second sides, the first side complementing the shape of the inner surface for engagement thereto, the second side concavely configured to receive the air bag disposed adjacent the door portion.

12. The assembly of claim 11 wherein the retainer portion on the inner surface includes a hollow mounting post extending therefrom.

13. The assembly of claim 12 wherein the impact member includes an aperture through which the mounting post extends to facilitate heat-staking of the impact member to the retainer portion.

14. The assembly of claim 11 wherein the impact member is a molded cartridge having spaced ribs transversely formed thereon for dissipating input energy.

15. The assembly of claim 11 wherein the impact member includes spaced ribs transversely formed thereon for dissipating input energy.

16. The assembly of claim 15 wherein the impact member is heat-staked onto the retainer portion.

17. The assembly of claim 11 wherein the panel member is configured to be attached to a pillar in the vehicle compartment.

18. The assembly of claim 11 wherein the panel member is configured to be attached to a side panel in the vehicle compartment.

19. The assembly of claim 11 wherein the second side of the impact member is formed to cooperate with the door portion to house the air bag between the door portion and the second side of the impact member.
